(19) United States
(12) Patent Application Publication
(10) Pub. No.: US 2005/0268797 A1
(43) Pub. Date: Dec. 8, 2005

(54) Print unit in a machine for manufacturing tobacco products

(76) Inventors: Fiorenzo Draghetti, Medicina (IT); Andrea Montanari, Guiglia (IT)

Correspondence Address: Harbin King & Klima, 500 Ninth Street SE, Washington, DC, 20003, US

(21) Appl. No.: 11/143,669

(22) Filed: Jun. 3, 2005

(30) Foreign Application Priority Data
Jun. 4, 2004 (IT) BO2004A000357

(51) Int. Cl. B41F 17/10

(52) U.S. Cl. 101/36

(57) ABSTRACT

A cigarette maker is equipped with a print unit comprising a plurality of ink transfer and ink feed rollers disposed substantially tangential one to another, a printing roller by which lettering is impressed cyclically on a continuous strip of paper, and a main cooling circuit equipped with a refrigeration unit and a predetermined number of secondary cooling circuits, each routed through the body of a respective roller. With this arrangement, the single rollers of the print unit can be maintained at a predetermined uniform temperature along the full distance through which the ink is transferred, and over the entire expanse of the cylindrical surface presented by each roller.

### BACKGROUND OF THE INVENTION

The present invention relates to a print unit in a machine for making tobacco products, for example a cigarette maker or a filter maker.

Reference will be made explicitly in the present specification to a cigarette maker having either one or two tobacco rod processing lines, albeit no limitation is implied.

Conventionally, machines of the type in question are equipped with a special garniture assembly such as will cause a strip of paper material to wrap progressively around a continuous stream of tobacco filler, forming a continuous cigarette rod from which single cigarette sticks are then separated by a rotary cut-off head.

It is also a common practice to print lettering and logos on the paper material, indicating the type of tobacco and/or the brand of the particular cigarette. The impression is made utilizing a print unit positioned along the feed path followed by the strip.

The print unit operates at the same frequency as the rotary cut-off head, and is timed relative to the cutting stroke in such a way that all of the cigarettes will emerge with the aforementioned lettering in a predetermined position.

The architecture of the print unit is relatively complex, in view of the need to ensure good print definition even at high operating speeds.

In effect, such a unit will typically comprise a train of rotating elements disposed tangential one to another, consisting in a plurality of inking rollers and a print roller equipped with cliches.

It has been found that the components making up the print unit are subject to a gradual rise in temperature during the operation of the cigarette or filter maker, sufficient to alter the viscosity of the ink to the point that the quality of the print becomes degraded.

This drawback is notably evident in cigarette and filter makers of the latest generation, since the temperatures generated by the ultra high operating speeds of these machines tend to reach critical values, as regards their effect on the viscosity of printing inks (above a given temperature, printing is no longer possible).

An initial attempt to overcome the drawback in question consisted in modifying the quality of the ink by introducing additives or solvents such as would maintain its viscosity within acceptable values even at high temperatures.

Substances of this nature were declared harmful subsequently and their use was banned, with the result that it became necessary to adopt measures whereby the temperature of the print unit, that is to say the temperature of the single components making up the unit, could be maintained within a prescribed limit.

This particular object is achieved conventionally by incorporating a cooling circuit into the means by which the print unit is supported, in particular a bulkhead carrying the train of rollers making up the unit.

Such a solution is not able, however, to maintain uniform temperature conditions in all parts of the print unit.

The need to maintain a uniform temperature is particularly noticeable in the case of machines equipped to manufacture two cigarette rods, where the print unit is made up of rollers presenting an appreciable longitudinal dimension, designed as they are to interact with a strip of paper material double the width of the strip utilized by a single rod machine.

The double width strip of material is divided by a longitudinal cut into two bands, then caused by the aforementioned garniture assembly to envelop two distinct streams of tobacco, thereby forming two continuous cigarette rods disposed parallel one with another, which are separated into discrete cigarette sticks by a single cut-off head.

In the event of the temperature not being uniform along the full length of the rollers, the lettering and the logos printed simultaneously on the two adjacent bands making up the double width strip of paper material may present noticeable differences in quality one relative to another.

This means that a high percentage of reject stock is produced, as quality control systems will pass neither cigarettes displaying defective print, nor cigarettes presenting characteristics that differ one from another within the same production run.

The object of the present invention is to provide a print unit comprising a plurality of rollers, in particular a train of rollers disposed tangential one to another, such as will function at controlled temperatures even when associated with a machine typified by high operating speeds.

### SUMMARY OF THE INVENTION

The stated object is duly realized according to the present invention in a print unit applicable to a machine for the manufacture of tobacco products, comprising a plurality of ink transfer and ink feed rollers disposed substantially tangential one to another, and a printing roller by which lettering is impressed cyclically on a continuous strip of paper.

The print unit disclosed is equipped with a main cooling circuit incorporating a refrigeration unit and a predetermined number of secondary circuits each routed internally through a respective roller.

### BRIEF DESCRIPTION OF THE DRAWINGS

The invention will now be described in detail, by way of example, with the aid of the accompanying drawings, in which:

FIG. 1 illustrates a portion of a cigarette maker equipped with the print unit according to the invention, viewed schematically and in elevation;

FIG. 2 illustrates a preferred embodiment of the print unit in FIG. 1, viewed schematically and in elevation, and in larger scale;

FIGS. 3 and 4 show a detail of the print unit in FIG. 2, illustrating two respective embodiments, viewed schematically and in elevation;

FIGS. 5 and 6 show a detail of the print unit in FIG. 2, illustrating two respective embodiments, viewed schematically and in section;

FIG. 7 shows a detail of the print unit in a further embodiment, viewed in perspective.

### DESCRIPTION OF THE PREFERRED EMBODIMENTS

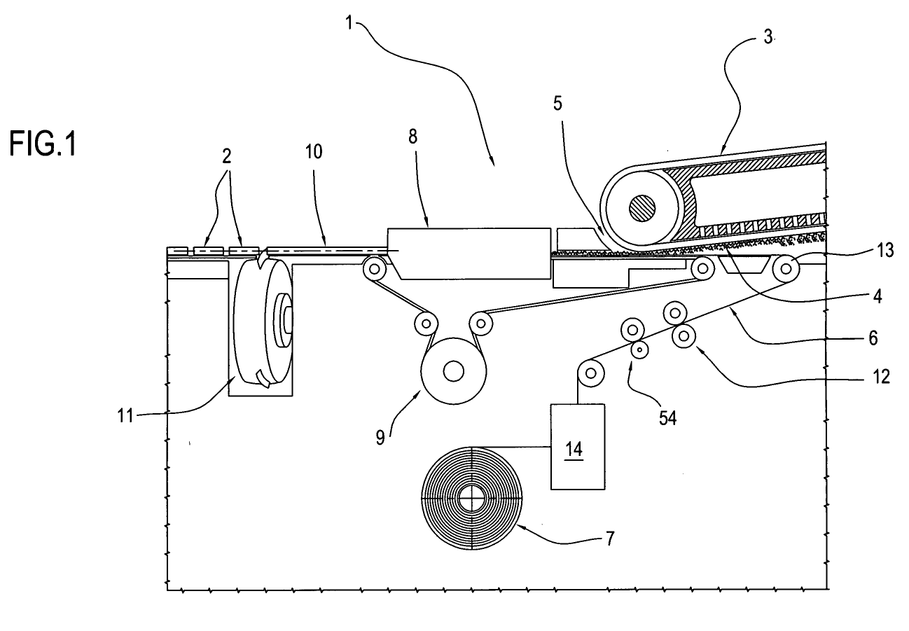

Referring to FIG. 1 of the drawings, 1 denotes a portion of a machine for making cigarettes 2.

The machine 1 comprises a device 3 by which a continuous stream 4 of shredded tobacco is first formed and then released at a transfer station 5 onto a strip of paper 6 decoiled from a roll 7 and directed along a horizontal tongue 8, carried on the upward facing branch of an endlessly looped fabric belt, or garniture tape 9.

As the strip 6 advances along the tongue 8, it is forced by the tape 9 to wrap progressively around the stream 4 of tobacco so that the two are formed into a continuous cigarette rod 10.

The continuous rod 10 is divided up into single cigarette sticks 2 by a rotary cutter 11.

The strip of paper 6 is decoiled from the roll 7 by a pair of pinch rolls 12 and, before passing around a relative pulley 13 into the aforementioned transfer station 5, directed through a print unit represented schematically in FIG. 1 by a block denoted 14.

The print unit 14 operates at the same frequency as the rotary cutter 11 and is timed selectively, relative to the selfsame cutter, in such a manner that each of the individual cigarette sticks 2 will emerge with lettering positioned at a predetermined point on the relative surface.

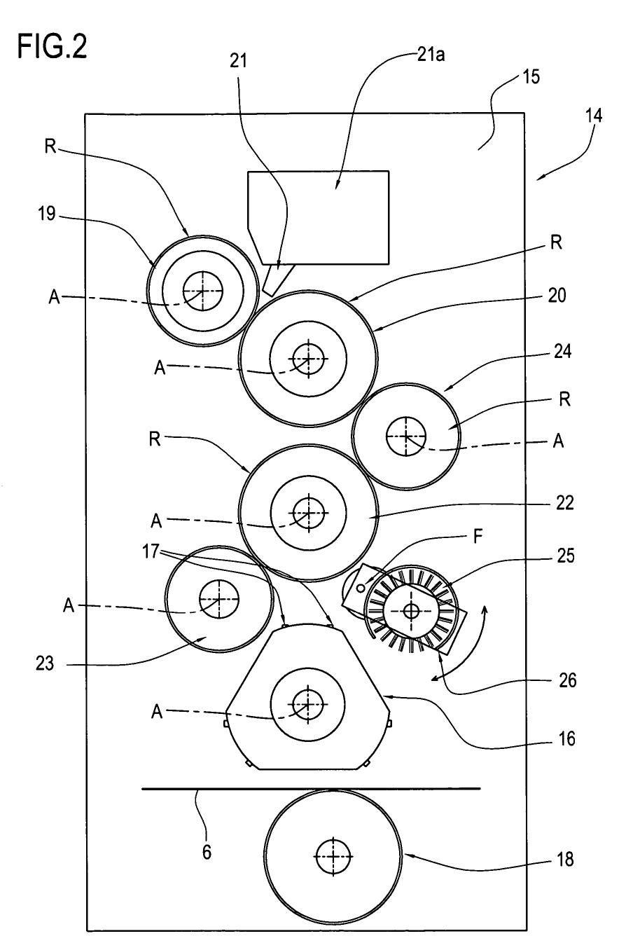

With reference to FIG. 2, the print unit 14 is carried by a vertical bulkhead 15 of the machine 1 and comprises a plurality of rotary elements R arranged in a train, substantially tangential one to another, centered on respective axes A disposed mutually parallel and normal to the bulkhead 15.

The rotary elements R consist in rollers by which ink is transferred and fed to a printing roller 16 equipped on the peripheral surface with respective cliches 17 and operating in conjunction with an impression roller 18.

The strip of paper 6 is directed between the printing roller 16 and the impression roller 18 and marked cyclically by the cliches 17.

More exactly, and considered relative to the flow direction of the ink, the aforementioned transfer and feed rollers comprise an upstream first inking roller 19 and a downstream first spreader roller 20 between which a nozzle 21, located adjacent to the line of tangential association between the rollers, dispenses ink from a relative tank 21a.

The transfer and feed rollers R further comprise a second spreader roller 22, and a second inking roller 23 by which ink is applied to the clichés 17 of the printing roller 16.

A third inking roller, denoted 24, is interposed between the two spreader rollers 20 and 22.

Besides being rotatable about their respective axes A, conventionally, the two spreader rollers 20 and 22 are also translatable to and fro along the selfsame axes A in order to ensure a more thorough distribution of the ink over the respective inking rollers 24 and 23.

25 denotes a cleaning roller that consists in a brush rotatable about a respective axis A parallel to the roller axes A and carried by a bracket 26 mounted pivotably to a fulcrum F of which the axis extends parallel to the brush axis A. The brush is capable thus of angular movement between an at-rest position, illustrated in FIG. 2, and an operating position in which the tips of the bristles engage and clean the cliches 17 of the printing roller 16.

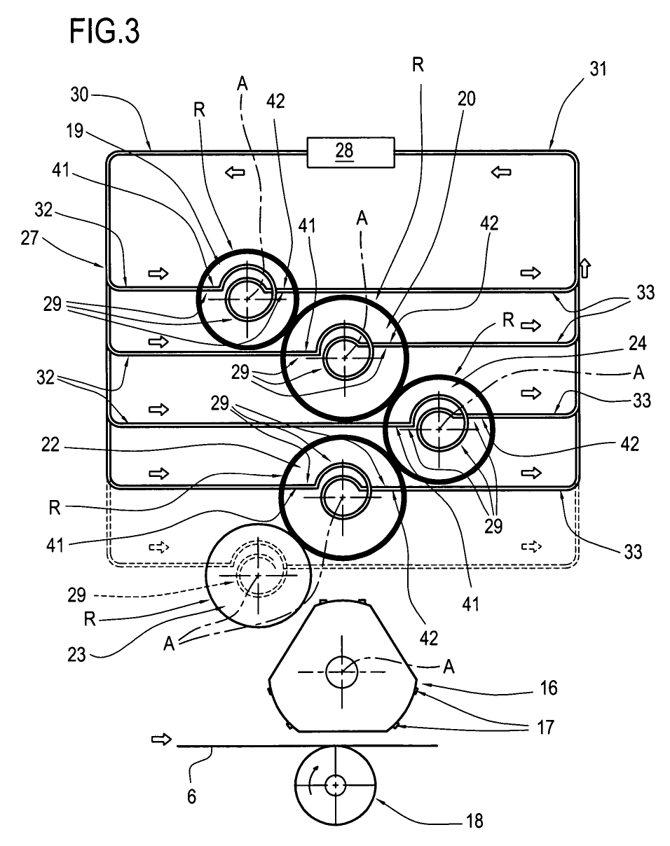

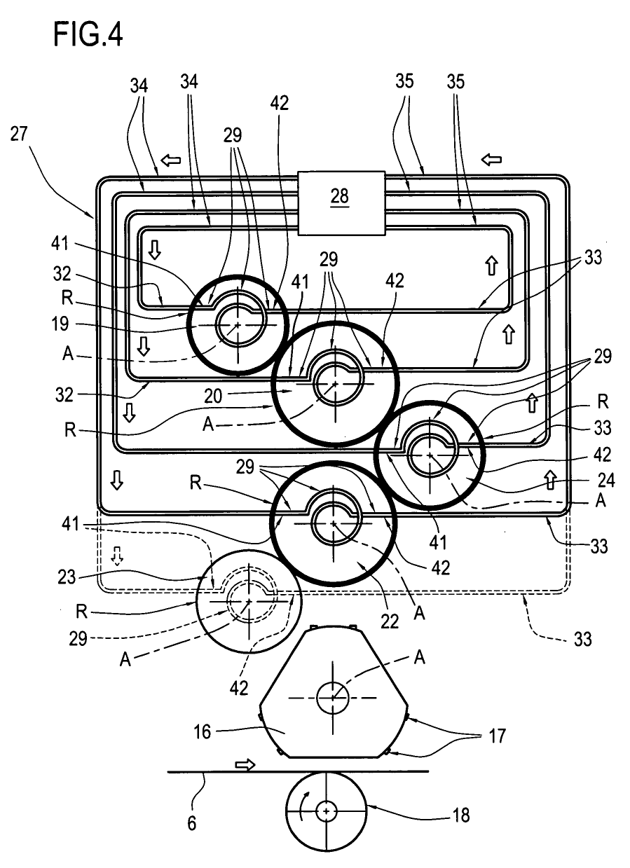

Referring to FIGS. 3 and 4, the print unit 14 comprises a main cooling circuit, denoted 27 in its entirety and including a refrigeration unit shown as a block, denoted 28, also a predetermined number of secondary circuits 29 each associated with a respective roller R of the print unit 14.

In the embodiment of FIG. 3, the secondary cooling circuits 29 are connected in parallel to the refrigeration unit 28 by way of a common flow line and a common return line, denoted 30 and 31 respectively. More exactly, each of the secondary circuits 29 is connected to the common flow and return lines by a respective inlet branch 32 and a respective outlet branch 33. It will be seen that the inlet and outlet branches 32 and 33 serving the second inking roller 23 are indicated by phantom lines, given that this roller could also operate without the relative secondary circuit 29.

The main cooling circuit 27 shown in the example of FIG. 4 differs from that of FIG. 3 in that the inlet branches 32 and the outlet branches 33 of the secondary circuits serving the rollers R are connected to the refrigeration unit 28 by way of respective flow lines 34 and respective return lines 35 embodied independently of one another. In other words, the inlet branch 32 and the outlet branch 33 serving each roller R are looped into the refrigeration unit 28 directly. Likewise in this instance, and for the same reasons as stated above, the inlet and outlet branches 32 and 33 of the second inking roller 23 are indicated by phantom lines, given that this roller could also operate without the relative secondary circuit 29.

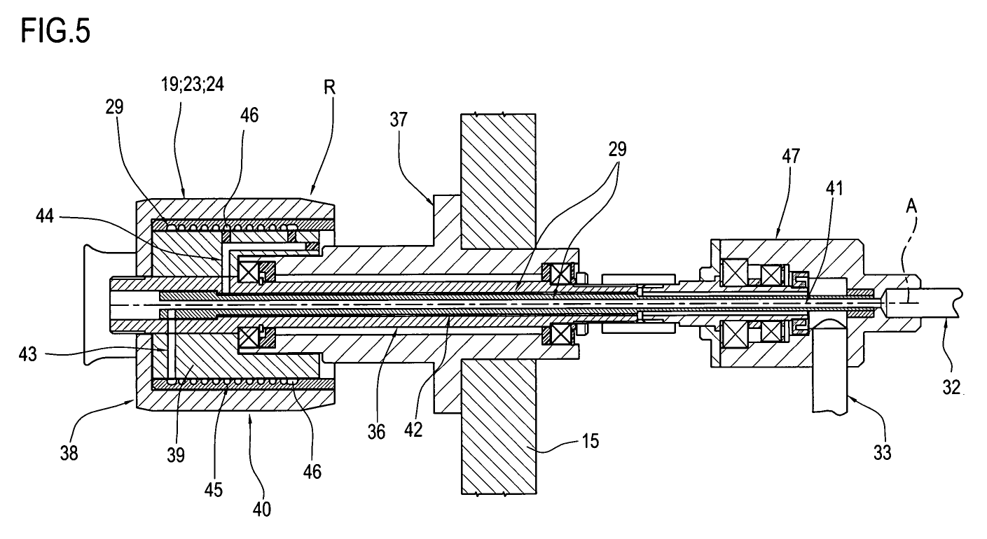

As illustrated in FIG. 5, the single roller R, in this instance an inking roller 19, 23 or 24, is carried on a shaft 36 rotatable about the relative axis A and mounted to the vertical bulkhead 15 via an interposed fixed tubular bearing block 37. The shaft 36 carries a cylindrical element 38, keyed to the free end, composed of an inner core 39 and a cupped outer cylindrical body 40. In practice, the inking rollers 19, 23 and 24 are freely revolving members set in rotation by virtue of their being in tangential contact with the two spreader rollers 20 and 22.

The secondary cooling circuit 29 associated with the roller R comprises an inlet duct 41 extending coaxial with and internally of the shaft 36 and an outlet duct 42 coaxial with and externally of the shaft 36. The ducts 41 and 42 are connected by way of respective radial inlet and outlet connecting portions 43 and 44 to an intermediate duct 45 of which one portion 46 extends spirally along a part of the core 39 breasted in contact with an internal surface of the cupped outer cylindrical body 40. The inlet and outlet ducts 41 and 42 are connected to the inlet branch 32 and to the outlet branch 33, respectively, by way of a rotary fluid coupling 47.

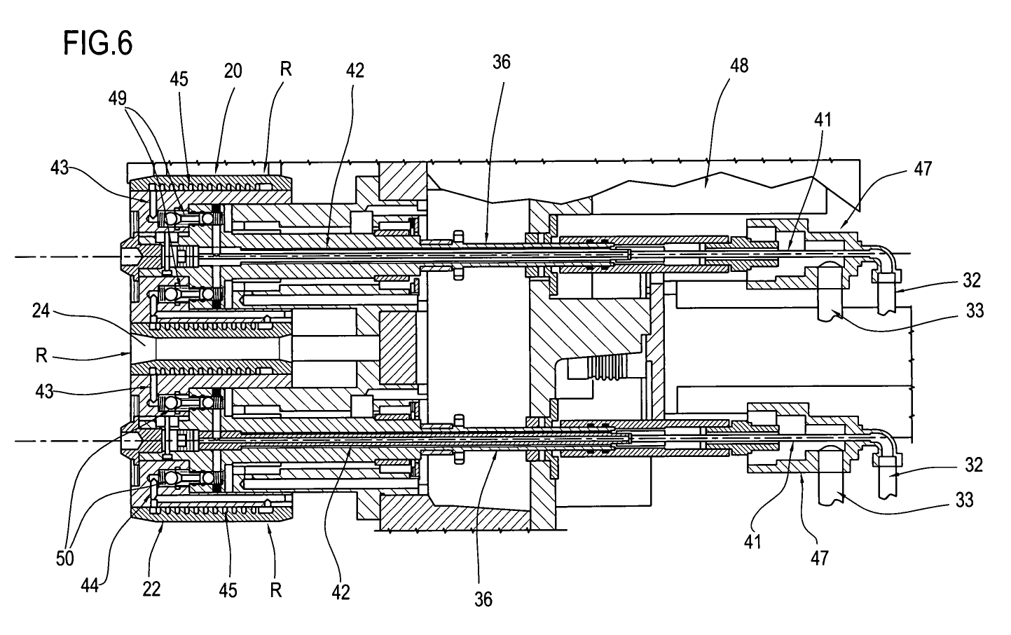

FIG. 6 illustrates three rollers R, and more exactly the two spreader rollers 20 and 22 and the inking roller 24 located between them. The print unit 14 will be seen also to comprise a motor 48 by which the shafts 36 of the two spreader rollers 20 and 22 are driven in rotation indirectly through a mechanical linkage not illustrated in the drawings; in addition, the spreader rollers 20 and 22 are caused to reciprocate axially in familiar manner, likewise not illustrated, so as to favor a uniform distribution of the ink over the inking rollers.

In this embodiment, the two rollers 20 and 22 are equipped with first and second valve means 49 and 50 interposed between the intermediate duct 45 and the inlet and outlet ducts 41 and 42, respectively, and more particularly along the radial connecting portions 43 and 44. Such valve means will allow the removal of the roller R for maintenance, cleaning and replacement purposes without the risk of liquid escaping from the cooling circuit.

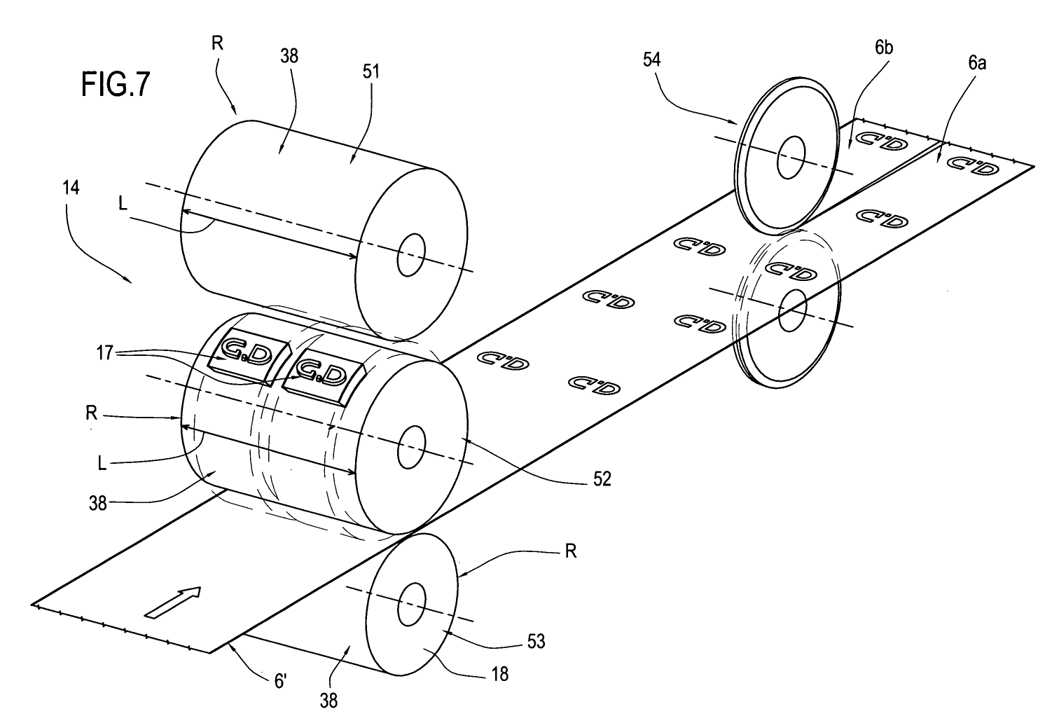

FIG. 7 shows an inking roller 51, a printing roller 52 and an impression roller 53 forming part of a machine 1 with two processing lines.

In a machine 1 of this type, the strip of paper material, denoted 6′, is conventionally double the width of the strip utilized by a machine with a single processing line. The strip 6′ is divided longitudinally by a relative cutter unit 54 into two identical bands 6a and 6b which are then caused by the tongue 8 to wrap progressively around two distinct streams 4 of tobacco, thereby fashioning two continuous cigarette rods 10.

Accordingly, the cylindrical elements 38 of the rollers R making up the print unit 14 of FIG. 7, or rather the portion of the roller 51 serving to transfer the ink, and the portion of the printing roller 52 carrying the cliches, will present a longitudinal dimension L substantially twice the corresponding dimension 1 presented by the cupped cylindrical bodies 40 of the rollers R illustrated in FIGS. 3, 4, 5 and 6.

In particular, the printing roller 52 is equipped with two sets of cliches 17, arranged in axially aligned pairs, by which lettering or logos can be impressed simultaneously on the two bands 6a and 6b of paper.

In operation, a print unit 14 according to the present invention, equipped with the cooling system described and illustrated, will allow a prescribed temperature to be maintained uniformly along the full distance through which the ink is transferred, and over the entire expanse of the cylindrical surface presented by each roller.

Thus, in the particular case of a cigarette maker equipped with dual processing lines, the lettering impressed on the two bands 6a and 6b of the strip of paper 6′ will be reproduced identically.

1) A print unit in a machine for manufacturing tobacco products, comprising:
a plurality of ink transfer and ink feed rollers disposed substantially tangential one to another;
a printing roller by which lettering is impressed cyclically on a continuous strip of paper;
a main cooling circuit comprising a refrigeration unit;
a predetermined number of secondary circuits each routed internally through a respective roller.

2) A print unit as in claim 1, wherein the secondary cooling circuits associated with the single rollers are arranged in parallel and connected together to the refrigeration unit by a common flow line and a common return line.

3) A print unit as in claim 1, wherein the secondary cooling circuits associated with the single rollers are arranged in parallel and connected to the refrigeration unit independently, each by a respective flow line and a respective return line.

4) A print unit as in claim 2, wherein each roller comprises a shaft and a cylindrical element, and is equipped with a secondary cooling circuit comprising an inlet duct and an outlet duct extending along the shaft and connected one with another by way of an intermediate cooling duct incorporated into the cylindrical element.

5) A print unit as in claim 4, wherein the inlet duct and the outlet duct extend coaxially with the shaft of the roller.

6) A print unit as in claim 4, wherein the inter-mediate cooling duct extends along a spiral portion of the secondary circuit incorporated into the cylindrical element of the roller.

7) A print unit as in claim 1, wherein the inlet duct and the outlet duct are connected respectively to the common flow line and to the common return line by way of a rotary fluid coupling.

8) A print unit as in claim 1, wherein the inlet duct and the outlet duct are connected to the respective flow line and to the respective return line by way of a rotary fluid coupling.

9) A print unit as in claims 4, wherein the secondary cooling circuit comprises first and second valve means interposed respectively between the intermediate duct and the inlet duct and between the intermediate duct and the outlet duct.

10) A print unit as in claim 1, wherein the machine for manufacturing tobacco products is a machine producing two tobacco rods simultaneously, and the longitudinal dimension presented by the cylindrical element of the single roller is substantially equal to the transverse dimension of a strip of paper material twice the width of a strip used by a machine producing a single tobacco rod.

11) A print unit as in claim 3, wherein each roller comprises a shaft and a cylindrical element, and is equipped with a secondary cooling circuit comprising an inlet duct and an outlet duct extending along the shaft and connected one with another by way of an intermediate cooling duct incorporated into the cylindrical element.

12) A print unit as in claim 11, wherein the inlet duct and the outlet duct extend coaxially with the shaft of the roller.

13) A print unit as in claim 12, wherein the inlet duct and the outlet duct are connected to the respective flow line and to the respective return line by way of a rotary fluid coupling.

14) A print unit as in claim 11, wherein the inter-mediate cooling duct extends along a spiral portion of the secondary circuit incorporated into the cylindrical element of the roller.

15) A print unit as in claim 14, wherein the inlet duct and the outlet duct are connected to the respective flow line and to the respective return line by way of a rotary fluid coupling.

16) A print unit as in claim 1, wherein each roller comprises a shaft and a cylindrical element, and is equipped with a secondary cooling circuit comprising an inlet duct and an outlet duct extending along the shaft and connected one with another by way of an intermediate cooling duct incorporated into the cylindrical element.

17) A print unit as in claim 16, wherein the inlet duct and the outlet duct extend coaxially with the shaft of the roller.

18) A print unit as in claim 16, wherein the inter-mediate cooling duct extends along a spiral portion of the secondary circuit incorporated into the cylindrical element of the roller.

19) A print unit as in claim 5, wherein the inlet duct and the outlet duct are connected respectively to the common flow line and to the common return line by way of a rotary fluid coupling.

20) A print unit as in claim 6, wherein the inlet duct and the outlet duct are connected respectively to the common flow line and to the common return line by way of a rotary fluid coupling.
